(19) United States
(12) Patent Application Publication
(10) Pub. No.: US 2012/0221250 A1
(43) Pub. Date: Aug. 30, 2012

(54) SYSTEM AND METHOD FOR MONITORING THE FEEDING PRACTICES OF INDIVIDUAL ANIMALS IN A GRAZING ENVIRONMENT

(75) Inventor: David John Cottle, Armidale (AU)

(73) Assignee: THE UNIVERSITY OF NEW ENGLAND, Armidale, New South Wales (AU)

(21) Appl. No.: 13/391,116

(22) PCT Filed: Aug. 19, 2010
(86) PCT No.: PCT/AU2010/001054

§ 371 Date: May 3, 2012

(30) Foreign Application Priority Data
Aug. 19, 2009 (AU) 2009903912

(51) Int. Cl. G06F 19/00

(52) U.S. Cl. 702/19

(57) ABSTRACT

There is disclosed a method for the management of animals grazing in a pasture, comprising feeding a marker labelled supplement to grazing animals. Monitoring consumption of said marker labelled supplement by said animals to generate supplement consumption data for said animals. Measuring physical characteristics of said animals to generate physical characteristic data for said animals. Collecting faecal samples from said animals. Analysing said faecal samples, samples of said pasture and said supplement to generate faecal data, pasture data and supplement data and processing Said supplement consumption data, said physical characteristic data and said fecal data, pasture data and supplement data to determine individual animal diet and nutritional information for animal management purposes.

### FIELD OF INVENTION

The present invention relates to a system and method for monitoring the feeding practices of individual animals in a grazing environment to obtain data suitable for use in estimating various practical considerations for animal management, and in particular, to a system and method for monitoring the feeding practices of individual grazing livestock to facilitate the estimation of various characteristics such as pasture intake, feed use efficiency, methane production and the like, for animal selection, animal or feed management or research purposes.

### BACKGROUND OF THE INVENTION

The feeding practices of individual animals provide an important insight into the health, productivity and quality of the animal and system efficiency. As such, the ability to monitor and, where necessary, alter such feeding practices is of paramount importance in the area of animal management.

By monitoring the feed consumption and behaviour of individual animals many primary producers are able to monitor the weight loss or gain of individual animals in relation to their food intake in order to predict and determine a variety of conditions. These conditions may relate to the health and performance of individual animals, as well as the overall efficiency, quality and safety of the animals as a group, and enables the ability to identify any animals that may require physical intervention or treatment or culling from the herd or flock.

As such, a variety of processes and systems have been proposed to assist in monitoring the feeding practices of animals. Typically, most existing processes and systems have specific application to monitoring feed consumption and behaviour of animals in feedlots. Such feedlots typically comprise arrangements whereby large numbers of livestock at various stages of growth are supplied food by way of automatic feeding bins in accordance with specific dietary requirements. Many of the proposed systems and processes incorporate remote sensing of data by reading data from radio frequency (RF) identification ear tags associated with the animal. These systems are designed to not only identify the individual animal feeding at the feeding bin but to also measure the amount or weight of food consumed by the animal. However, such processes and systems are typically limited to feedlot situations whereby all of the animal's diet is provided via the feeding bins such that operators can be continuously and accurately apprised of the health, gain efficiency and performance of each animal and are able to identify and remove any non-performing animals early in the feeding process.

In grazing situations whereby an animal's food intake comprises pasture intake as well as the intake of one or more food supplements, the ability to continuously and accurately monitor feed consumption of individual animals is difficult to achieve. Measurement of pasture feed intake has typically only been carried out in experimental, non-commercial situations. Such methods mostly rely upon the use of indigestible markers. The odd-chain hydrocarbons (n-alkanes) which occur naturally in plant cuticular wax have been used as markers to estimate feed intake since the late 1980s. In such systems, a known amount of an even-chain alkane is given to the animal either by daily dosing by labelling a concentrate with, typically, C32 or C36 alkane. Such a process requires separate manual administration of a known amount of supplement and requires the need to ensure and verify steady-state delivery rates either from pulse dosing or by administering an intra-ruminal controlled-release device (CRD).

In such methods, the intake is estimated from the faecal ratio of the dosed even-chain alkane and an adjacent odd-chain alkane originating from the forage, the measured alkane concentrations of these two alkanes in the forage and the known dose of dosed alkane. A problem with such a method employing a marker is obtaining a representative sample of the forage consumed. In this regard, whilst the alkane method has been demonstrated to work in sheep, relatively less work has been done with cattle.

In essence, such a method requires that the recovery in faeces of the alkane pair is equal and validation studies have shown that these recoveries are usually close. The estimate of intake is directly related to the release rate of even-chain alkane from the CRD, and thus can be compromised by irregular alkane release from the CRD. In order to obtain absolute estimates of intake, the actual alkane release rate under the conditions of the experiment must be known, although a comparison of estimated intakes between experimental treatments is still valid when based on the manufacturer's stated release rates. Release rate can be determined by measuring the end-point of release by frequent faecal sampling or by measurement of the disappearance of CRD payload in the rumen. Estimating release rate thus requires additional animal intervention, which can be difficult under certain conditions. Further, such a method is very labour intensive, particularly in relation to the need to ensure and verify steady-state delivery rates either from pulse dosing or by administering a CRD, and thereby has limited commercial applicability.

As a result of the above drawbacks, it has traditionally been difficult to monitor and to collect useful data associated with the individual feeding practices of grazing animals.

This has been further hampered by the unavailability of suitable CRDs for commercial use.

Nevertheless, the ability to obtain information in the form of useful data from individual grazing animals is important for many primary producers and others, particularly in determining pasture intake, feed use efficiency, methane production and the like. Such information can have a significant impact on livestock production system efficiency, as well as on issues associated with global warming and climate change, which are becoming increasingly important to monitor and understand.

The ability to select livestock which have lower maintenance requirements and consume less feed for a given level of production (high Net Feed Efficiency or low Net/Residual Feed intake; NFI) is a focus of research globally. This NFI trait is moderately heritable but the high cost of measurement and problems with an available test have resulted in limited selection for NFI by the ruminant industries. Industry benefits will only come with the availability of a suitable and accurate feed intake measurement and by jointly selecting a production trait(s) as well as NFI or feed intake. The indirect traits most likely to be of use for reducing methane production are those associated with feed intake and the efficiency of its use.

Further, with the increasing focus on carbon pollution and the future need for emission control by industries, it is likely that the agricultural industry will also need to monitor and control such emissions. As such there is a need to provide a simple and accurate system that has the capability of monitoring and quantifying animal methane production.

As such, there is a need to provide a simple, cost effective and accurate system and Method for monitoring the feeding practices of individual animals in a grazing environment that provides useful data suitable for use in monitoring and improving animal efficiency.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

In a general form, the present invention provides an integrated system of feeding stations, marker technology and software that can be used for ruminants, such as either sheep, goats, alpaca, beef or dairy cattle in grazing situations to allow the calculation of individual supplement intake, pasture intake, intake of pasture components, feed use efficiency, feed wastage, feed supplement requirements and indirectly methane production for animal breeding, management and/or experimental purposes. The present invention therefore provides an integrated system that works successfully with large and small ruminants in pasture grazing situations. The invention is the combination of the components of the system into an integrated system for commercial and experimental use.

Accordingly, in one aspect of the invention there is provided a system for monitoring the feeding characteristics of grazing animals in a pasture comprising:
one or more feeding bins for dispensing supplement to said grazing animals, at least one of the feeding bins being configured to identify each animal receiving supplement therefrom and being configured to measure and record an amount of supplement being dispensed to each animal;
a marker labelled supplement for dispensing from the one or more feed bins to at least one animal;
a weighing device for determining weight gain of each individual animal;
a faeces collection means for obtaining faecal samples from at least one of said grazing animals;
an analysis means for analysing said faecal samples and samples of supplement and pasture components to provide data representative of marker concentrations in an animal's faecal sample, pasture component samples and the supplement; and
a processor for receiving said amount of supplement being dispensed to an animal, the weight gain of the animal and data representative of marker concentrations in an animal's faecal sample, pasture components and the supplement and processing said data to determine an animal's pasture feed intake, the animal's feed use efficiency, feed wastage and supplement requirements and/or methane production for animal breeding, management or experimental purposes.

In another aspect, the invention provides a method for monitoring the feeding characteristics of a grazing animal comprising the steps of:
dispensing either solid or liquid supplement to said grazing animal containing a marker labelled supplement;
identifying said animal receiving said supplement and storing information associated with an amount of supplement being dispensed to said animal;
weighing said animal and storing information pertaining to weight gained by each animal;
collecting faecal samples from said animal;
analysing said supplement, said pasture component samples and said faecal samples to provide data representative of marker concentrations in said animal's faecal sample, pasture component samples and the supplement;
processing said information associated with an amount of supplement dispensed to said animal, the information pertaining to weight gained by said animal and data representative marker concentrations in said animal's faecal sample, pasture sample and the supplement; and

generating data to determine said animal's pasture feed intake, feed use efficiency and/or methane production for animal breeding or experimental purposes.

In another aspect, the present invention provides an automated system for assisting in the determination of the breeding value of animals for (pasture and/or supplement) feed intake and feed use efficiency and methane production comprising:
one or more feed bins configured to dispense supplement to individual animals and to record amount of supplement being dispensed to each animal to determine individual supplement intake for each animal, wherein the supplement includes labelled supplement allowing marker concentrations to be used to determine individual animal pasture intake;
software to allow the export of spreadsheet files containing data compatible with a format required by a third party software system;
genetic selection index software to enable the calculation of EBVs for animal selection; and
software to enable the calculation of methane emissions from individual animal feed intakes and the total emissions summed from all measured animals.

This is achieved by using published relationships between feed intake and methane production. Methane sniffing devises may also be placed on the rims of the feed bins to directly measure methane emissions. The methane production is expressed in various units, including the proportion of feed metabolisable energy lost as methane on an individual animal or a herd/flock average basis.

Each feed bin or measurement unit may comprise one or more load cells to determine amount of supplement consumed by each animal and an RFID reader to identify each individual animal. The measurement units may be portable enabling movement to different paddocks, sharing of units, filling of units with supplement and maintenance of the unit.

A computer program may determine whether an animal has lost a transmitter or the rfid has ceased to function. The computer program may also determine an interval head count and inventory of all animals being monitored. In another form, the computer program may determine consumption intake by measuring the loss in feed bin weight during feeding events matched to rfid tags.

The computer program may calculate individual pasture intake from supplement intake and marker concentrations in supplement, feed and faeces. The computer program may also determine feed use efficiency and liveweight gain of individual animals. The computer program may also determine the ranking of animals for breeding based on EBVs for feed use efficiency and/or methane production or may be used to provide raw data in the appropriate format for breeding bureaus, e.g. Breedplan™. The computer program may also calculate the least cost supplement requirements for individual animals or the whole flock or herd. The computer program may also calculate feed wastage and/or the biological efficiency of the livestock system.

### BRIEF DESCRIPTION OF THE DRAWINGS

The invention may be better understood from the following non-limiting description of preferred embodiments, in which:

FIG. 1 is a top view of a feeding station employing individual feed measuring bin arrangement for dispensing supplement according to one embodiment of the present invention;

FIG. 2 is a top view of a feeding station employing a multiple feed measuring bin arrangement for dispensing supplement according to an alternative embodiment of the present invention;

FIG. 3 is a block diagram showing the steps and processes of the present invention according to a preferred embodiment;

FIG. 4 is a flow diagram showing the software modules of the processing device of the present invention according to a preferred embodiment thereof;

FIG. 5 is an exemplary data screen capture from the Supplement Intake module of the software of the present invention;

FIG. 6 is an exemplary data screen capture from the Diet Analysis Module of the software of the present invention;

FIG. 7 is an exemplary data screen capture from the Diet Analysis Module of the software of the present invention;

FIG. 8 is an exemplary data screen capture from the Batch Input module of the Diet Analysis Module of the software of the present invention;

FIG. 9 is an exemplary data screen capture from the Diet Analysis Module of the software of the present invention;

FIG. 10 is an exemplary data screen capture from the Diet Analysis Module of the software of the present invention;

FIG. 11 is an exemplary data screen capture from the Diet Analysis Module of the software of the present invention;

FIG. 12 is an exemplary data screen capture from the Diet Analysis Module of the software of the present invention;

FIG. 13 is an exemplary data screen capture from the Diet Analysis Module of the software of the present invention; and

FIG. 14 is an exemplary data screen capture from the Nutrition Module of the software of the present invention;

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

The system and method of the present invention will be described below in relation to its application for use with monitoring and estimating various characteristics associated with grazing cattle. However, it will be appreciated that the present invention is equally applicable to a variety of other grazing animals, such as sheep, goats, alpaca, and both beef and dairy cattle.

The system and method of the present invention provides an integrated system of feeding stations, marker technology and software that can be used to allow the generation of a variety of data relating to, for example, individual supplement intake, pasture intake, pasture components intake, feed use efficiency, feed supplement requirements, feed wastage, and methane production for animal breeding, management, or experimental purposes.

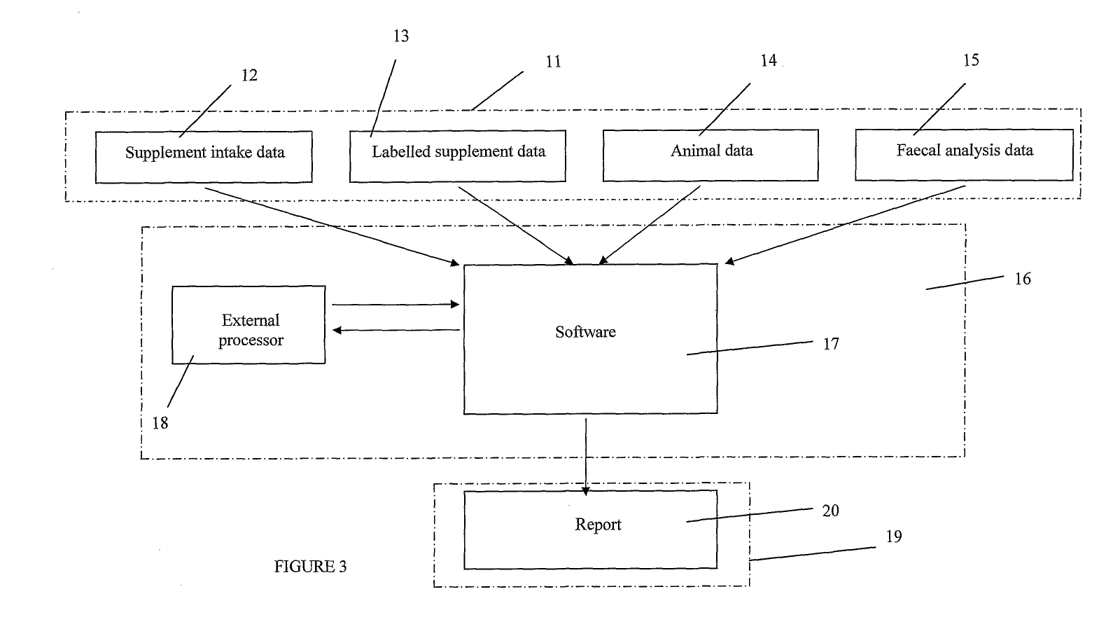

Referring to FIG. 3, the method 10 according to a preferred embodiment of the present invention is shown. The method 10 comprises a number of separate stages represented as dashed boxes 11, 16 and 19.

Stage 11 relates to a data collection stage of the present invention. In stage 11 real data is collected from the field in a variety of separate steps 12-15. In step 12, data associated with individual animal intake of a supplement is collected from feed bins accessed by the animals. In step 13 data associated with labelled markers provided with the supplement is collected. In step 14, individual animal growth and development data is collected through weighing the animal at controlled intervals and physically measuring animal characteristics. In step 15, data relating to an analysis of each individuals faeces is collected through controlled sampling of the animal's faeces and analysis at a laboratory.

In stage 16 of the present invention, a computer processor 17 having dedicated software is employed to receive the data collected from each of the steps of stage 11 and to process the data according to a variety of software modules. Each of the software modules can be accessed to generate a report or analysis of the data specific to the user's requirements. The processor 17 is able to store information which can be accessed by each software module to process the data into useful information. The processed data can be stored in a variety of formats that can be exported to external applications 18 for further processing and analysis.

In stage 19, the processor 17 prepares a report based on the data connected in stage 11 and software module selected by the user, to provide the user with a detailed analysis of a variety of parameters associated with individual animal and/or herd grazing practices. Such reports 20 can be used by the user for animal breeding, management, or experimental purposes. It will thus be appreciated that the present invention encompasses an overall system that is directed towards collecting raw data from the grazing animals in the field, analysing the data where appropriate and processing the data to provide useful information regarding the grazing habits and characteristics of the animals.

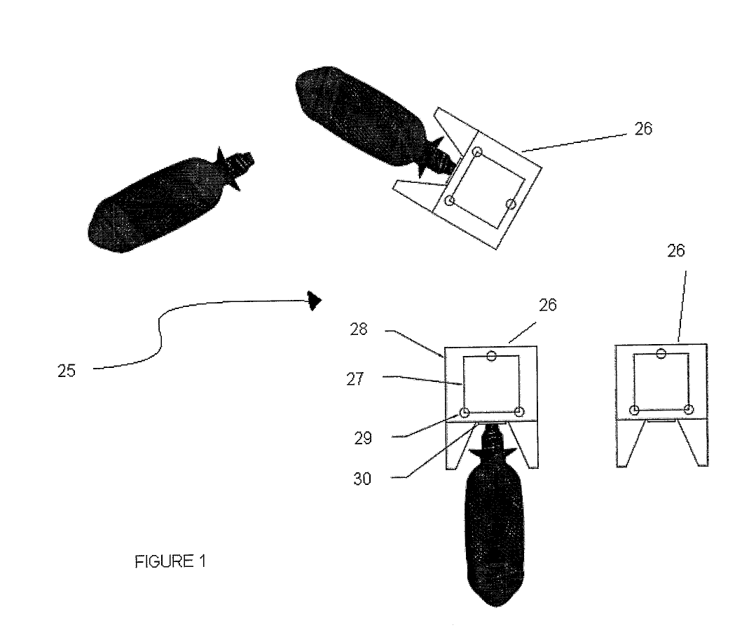

Each of the data collection steps 11-15 of stage 11 of the method of FIG. 1 will be discussed in more detail below.

Step 12—Measuring the Amount of Supplement Consumed by Individual Animals

As the present invention is specifically directed to grazing animals, in a preferred embodiment, a number of individual feeding stations are provided to facilitate the feeding of supplement to livestock as they graze in a pasture.

Referring to FIG. 1, an embodiment of a feeding station 25 is shown. The feeding station 25 comprises single feeding bins 26 that are able to accommodate one animal at a time. Typically the feeding bins 26 are strategically positioned in the paddock(s) in which the animals graze. The number of feed bins 26 provided is typically dependent upon the number of grazing animals able to access the bins 26. As such, one feed bin 26 per fifteen animals may be provided to accommodate the feeding requirements of the animals.

Each feed bin 26 comprises an outer case 28 that houses a hopper 27 which contains the supplement. The hoppers 27 are filled weekly with supplement for general access by the animals. The supplement can be purchased or made locally and the supplement may be in the form of dry material as well as molasses feeders.

In order to measure the amount of supplement each animal consumes, upon positioning the feed bins, the animals are free to access the feed bin(s) 26 at their own leisure in accordance with their feeding needs. Each feed bin comprises a load cell 29 that measures the change in weight of the hopper 27 being accessed by the animal to determine an amount of supplement that the animal has consumed each time it accesses the feed bin 26.

In order to identify individual animals, each animal is provided with an electronic identification tag, such as a radio frequency ID (RFID) tag, however other identification means are also envisaged for identifying the individual animal feeding at the feed bin 26. Such means may include transmitters generally attached to, injected, implanted or ingested by a particular animal which identifies the individual animal by a unique signal or other means of identification, e.g. retina recognition.

Where RFID tags are employed to identify each animal, RFID tag readers 30 are mounted to each of the feed bins, preferably adjacent to a rim thereof, as is shown in FIG. 1. By positioning the RFID tag readers 30 in such a location, each time the animal consumes supplement the animal's RFID tag is read and information regarding the feeding event is captured by a storage medium (not shown) provided with the feed bin 26. It will be appreciated that where individual feed bins 26 are employed (as shown in FIG. 1), the bins may be placed at least 5 m apart to minimise misreading of RFID ear tags.

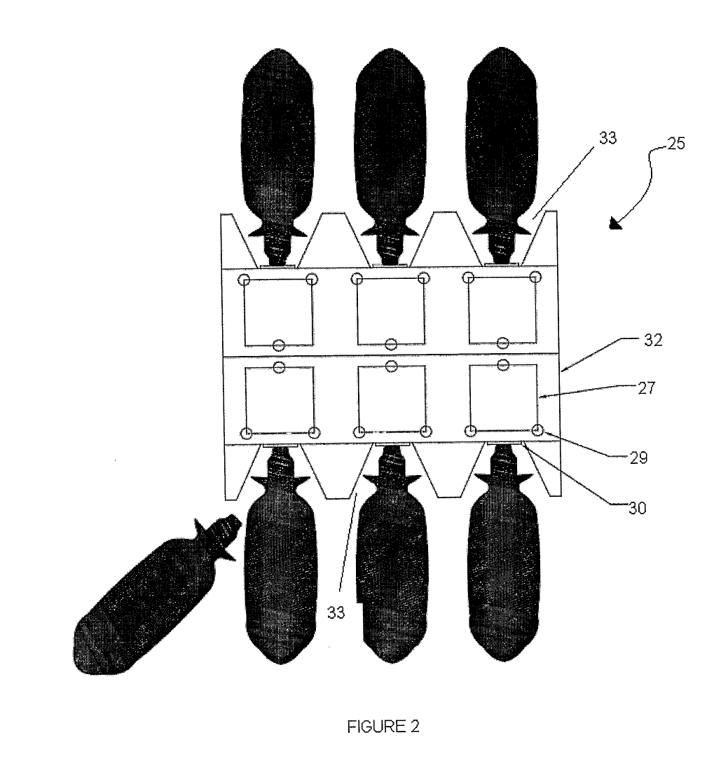

FIG. 2 shows an alternative embodiment of a feeding station 25. The feeding station 25 comprises a single bin 32 having multiple access points 33 that are each able to accommodate one animal at a time. As is shown, each access point has a hopper 27 with load cells 29 provided to measure the amount of supplement consumed by the animal at each feeding event. An RFID tag reader 30 is also mounted to each of the access points 33, preferably adjacent to a rim thereof, to identify the individual animal accessing the supplement. Each access point 33 employs a screening 34 that separates animals as they take in supplement to avoid contamination of the data collected through misreading of RFID ear tags.

Typically, the information collected by the feeding stations in step 12 includes the identification number of the animal (RFID), the date of the feeding event (DATE), the entry time of the animal accessing the feed bin (Ent), the exit time of the animal leaving the feed bin (Ext), bin weight prior to animal entry to bin (binwt/ent), and bin weight after exit of animal from bin (binwt/ext). Such data is linked in a data logger file retained in the storage medium which is downloaded as required by an operator. The frequency in which the information is downloaded may be weekly and the information may be downloaded to a memory stick or any other suitable device, such as a laptop computer, PDA, and the like. An example of the format the data may be collected is shown below in Table 1.

TABLE 1

| RFID | DATE | Ent | Ext | binwt/ent | binwt/ext |
|---|---|---|---|---|---|
| 999 000001234567 | 15102010 | 10.29 | 10.34 | 133.100 | 132.540 |
| 999 000001235998 | 15102010 | 11.28 | 11.33 | 132.540 | 132.160 |
| 999 000001234567 | 15102010 | 11.34 | 11.39 | 132.160 | 131.910 |
| 999 000001239725 | 15102010 | 12.39 | 12.44 | 131.910 | 131.454 |
| 999 000001232846 | 15102010 | 13.38 | 13.43 | 131.454 | 131.170 |
| 999 000001238247 | 15102010 | 15.48 | 15.53 | 131.174 | 130.854 |
| 999 000001238247 | 15102010 | 16.53 | 16.58 | 130.854 | 130.735 |
| 999 000001238247 | 16102010 | 9.12 | 9.18 | 130.734 | 130.375 |
| 999 000001234567 | 16102010 | 10.18 | 10.23 | 130.375 | 130.270 |
| 999 000001239725 | 16102010 | 11.23 | 11.28 | 130.270 | 129.520 |
| 999 000001239725 | 16102010 | 12.28 | 12.33 | 129.520 | 129.261 |
| 999 000001235998 | 16102010 | 14.49 | 14.54 | 129.261 | 128.953 |
| 999 000001232846 | 16102010 | 16.59 | 16.64 | 128.953 | 128.693 |

In this arrangement, as the animal accesses the feed bin it is identified and the amount of food consumed is logged in terms of the weight changes of the feed bin both immediately before the animal accesses the feed bin and immediately after the animal leaves the feed bin. It will be appreciated that the feed bin may also include a weigh platform to enable the weight of the animal to be recorded as it accesses the bin for the collection of more useful data about the specific animal which can be included in step 14 described below.

It will be appreciated that in order to avoid an individual animal gorging on supplement, access to the feed bins may be restricted in such instances. This may be achieved by monitoring each animal's access and when gorging by an individual animal is identified, isolating that animal from accessing the feed bins.

Step 13—Controlling Labelled Supplement Fed to Individual Animals

As discussed previously, the present invention employs a marker labelled supplement. Traditionally, indigestible markers in the feed have relied upon the odd-chain hydrocarbons (n-alkanes) which occur naturally in plant cuticular wax to act as markers to estimate feed intake since the late 1980s. In traditional methods a known amount of an even-chain alkane is given to the animal either by daily dosing, which is very labour intensive, by labelling a concentrate typically with C32 or C36 alkane, which requires manual administration of a known amount of supplement or by administering an intra-ruminal CRD.

In the present invention, it is appreciated that different plant species, and even cultivars within species, have different patterns of alkane concentration within their cuticular wax. These characteristic alkane patterns can be used to differentiate between forages (and other components) and to estimate their contribution to the diet from the aggregated faecal concentration of alkanes, using least-squares principles. As such, if diet composition can be estimated, it follows that if one feed component is given in a known quantity, it is possible to estimate the intake of all other feed components. In the present invention, it is the labelled supplement that is fed to the individual animals in known amounts, in the manner as described above in relation to the feeding stations.

It will be appreciated that various alternative marker labelled supplements could be used with the present invention, e.g. anthelmintics which can be sampled in the blood. The markers used are thus not restricted to alkanes but may be any relatively indigestible component. When chain lengths of compounds vary this helps differentiate different plant component species. Thus other compounds, such as long chain alcohols (LCOH), long chain fatty acids and terpenoids may be used, as well as other markers.

In this regard, in estimating diet composition in animals which are consuming a feed supplement, the supplement is effectively regarded as one of the ‘species’ in the diet. If diet composition can be estimated and the actual intake of one of the dietary components (e.g. the supplement) is known, then the intake of all other dietary components can be estimated. This approach can be extended to estimating the intake of up to four forage components in the diet. The accuracy of estimation of diet composition, and thus forage intake, can be increased by also using other cuticular wax markers, such as the long-chain alcohols (LCOH), in the estimation of diet composition. The predominant LCOH of grass species are C26OH and C28OH. The high C30OH concentrations in subterranean clover compared with the grass species has shown the usefulness of LCOH in distinguishing between the dicotyledons and monocotyledons in forage diets. Although the major pasture grass, phalaris, has very low alkane concentrations, its LCOH concentrations are of similar magnitude to other grasses.

According to the present invention, the feed bins are filled with marker labelled supplement, such as beeswax-coated cottonseed meal (CSM), but the supplement may also be in fluid form, e.g. molasses. This particular approach (‘labelled supplement’) of using the supplement as the means for estimating diet composition and thence component intakes eliminates the requirement for separate dosing with alkanes, or other chosen markers, thus removing the need to ensure and verify steady-state delivery rates either from pulse dosing or CRDs. In effect, the present invention employs a mix of alkanes or other chosen markers as ‘the dose’, and requires estimates of faecal alkane or other chosen marker recovery in the method of the present invention, to determine, amongst other things, the estimation of pasture diet composition.

According to a preferred embodiment of the present invention, the suggested supplement to be used in the system is solvent-extracted CSM labelled with beeswax±synthetic alkane or LCOH sources (ACSM) as alkane sources.

As an example, one type of labelled supplement based on beeswax plus C28 alkane, a tonne batch of ACSM is prepared in accordance with one embodiment of the present invention, as follows:

1000 kg CSM is labelled with 12.2 kg finely grated beeswax which had been dissolved in 56 L of n-heptane, with gentle heating. Synthetic C28 alkane (available from Sigma Aldrich Australia, Castle Hill, NSW) is also added to the solution to provide a final concentration of 250-300 mg alkane/kg organic matter (OM). These additions ensure an alkane profile of the ACSM supplement that is markedly different from all other dietary components. The beeswax/C28 solution is sprayed onto CSM as it is mixed in a horizontal mixer. The heptane solvent is then allowed to evaporate from the CSM at ambient temperature overnight.

The batch described would be prepared with a horizontal mixer and a pressure spray unit (e.g. a small paint spray unit). In the final product, the procedure would aim to achieve alkane (or LCOH) concentrations of the order of 150-250 mg/kg supplement. Supplement intakes of 200 g/day in sheep or about 2 kg/day in cattle, coupled with the above marker concentrations, would allow the estimation of herbage intake.

The feed bin reservoirs are replenished with ACSM weekly and animals are allowed free access for at least 7 days with their individual ACSM intakes monitored in the manner as described above. Labelled supplement would be continuously available from the feed bin for animal consumption.

The labelled supplement, e.g. ACSM, subsamples (5-50 g DM) are taken and sent to accredited laboratories, with information on identified, grazed, pasture species, to determine their dry matter (DM) concentration and are freeze-dried by the laboratory prior to their subsequent alkane and, depending on pasture composition, LCOH determination. Procedures for the solvent extraction, purification and analysis of alkanes or LCOH by gas chromatography are well known in the art. The selection of the group of alkanes to analyse by the laboratory is based on a database of multivariate analyses conducted to identify which alkanes best discriminate between particular pasture diets. NIR spectral analysis of faeces may also be used to calculate voluntary DMI if NIR calibration sets are available.

In essence, the individual animal intakes of indigestible markers of known concentration in a supplement are captured in this step of the process of the present invention to allow for the estimation of individual animal pasture feed intake during the processing stage 16 of the present invention. This, when combined with animal data such as liveweight gain obtained below in step 14, allows calculation of feed use efficiency, as will be discussed in more detail below.

Step 14—Measuring Animal Body Characteristics;

Together with collecting data about the amount of supplement consumed by each animal as it grazes and the composition of the labelled supplement, data pertaining to the growth and body characteristics of the animal are also captured in the present invention.

In a preferred embodiment of the present invention, the cattle are allowed to feed on the supplement for at least 6 days. After this time, the cattle are then weighed and the collected data is then uploaded to a storage device where it can be processed by system software on an appropriate computer system, such as a laptop, PC, PDA or similar handheld device.

The animals are weighed again 3-6 weeks later and the liveweight and animal identifications input into the system software. As will be appreciated, the animal data may be collected by a variety of pre-existing devices that can capture animal weight, fat and muscle depth measurements.

Other characteristics of interest that may be captured by this step is fibre weight and fibre diameter in sheep, goats and alpacas; milk yield and milk solids in dairy cattle and the like.

Step 15—Collecting Faecal Samples from Individual Animals

A fundamental aspect of the present invention is the collection of faecal samples from individual animals either in the field, in a race or in a crush, depending on the circumstances, e.g. animal species, facilities and labour.

A first faecal sample is typically taken after the cattle have been allowed to feed on the supplement for at least 6 days. A second faecal sample is obtained 2-3 days later and bulked with the first faecal sample from the same animal.

After 8-9 days of supplement feeding, the faecal samples identified in relation to the individual animals, and any supplement or feed samples, are sent for laboratory analyses.

As mentioned above, faecal samples can be readily obtained from confined animals. Samples can also be collected from recently voided faeces in the field, or faeces collected by gloved hand per rectum when animals are mustered into yards. Animals need to have been on the labelled supplement diets for at least 3-6 days before a faecal sample is taken.

There exist a variety of ways in which to take faecal samples. A convenient procedure is to visit the herd or flock where they are camped by water during the day; as animals stand they often defecate thus facilitating collection of fresh dung from a substantial number of animals in the herd. Samples are easily obtained from sheep in a race but cattle need to be constrained in a crush/head bail. It is possible to collect individual cattle or sheep faecal samples from the paddock by ensuring that the supplement consumed by different animals contains a small dose of different coloured plastic beads. Experience to date with the method indicates that intake can usefully be estimated from a bulked sample of 2-3 individual faecal samples.

A rectal sample of faeces (50-100 g DM for cattle, 5-10 g DM for sheep or goats) is obtained from each animal at least 6 days after initial access to the labelled supplement and then about 2-3 days later. The samples from one animal are bulked and placed in labelled containers with the animals identification details recorded on the sample container. The sample containers are supplied to an analytical laboratory. Samples can be sent by mail to the laboratory for alkane, and possibly LCOH, analyses, or analysis of whatever markers are being used.

The laboratory will then return the analytical marker results in the form of feed and individual animal faecal alkane and LCOH data for further processing by the dedicated system software.

At this point of the process or prior to this point, data from step 12, namely the feed bin data logger, may be downloaded to a portable memory, such as a memory stick, where it is later uploaded for analysis by the system software 17. The labelled supplement and the feed bins are then removed from the paddock if supplement is no longer required for production feeding of the animals. Otherwise, unlabelled supplement can be continued to be fed, although for weight gain and feed efficiency calculations, it is best that the animals graze in pasture only.

Processor

Once sufficient data has been collected from the field and received from the laboratory the data in Stage 11, can be processed in Stage 16 in accordance with the software of the present invention.

Software developed for, and supplied with, the system of the present invention may require any one or more of the following inputs:
1) Individual supplement intake patterns from the feed bin data loggers (step 12);
2) Individual feed and faecal alkane and LCOH (or other marker) data from the laboratory (step 13 and 15);
3) Individual liveweight gain from field data (step 14);
4) Chosen subset of traits for breeding analysis;
5) Chosen subsets of feedstuffs available for supplementation; and
6) Herd and/or flock structure information.

In accordance with a preferred embodiment of the present invention, each module described below is calculated on a linked sheet in a spreadsheet program. Other configurations of presenting the software are also envisaged and fall within the spirit of the present invention.

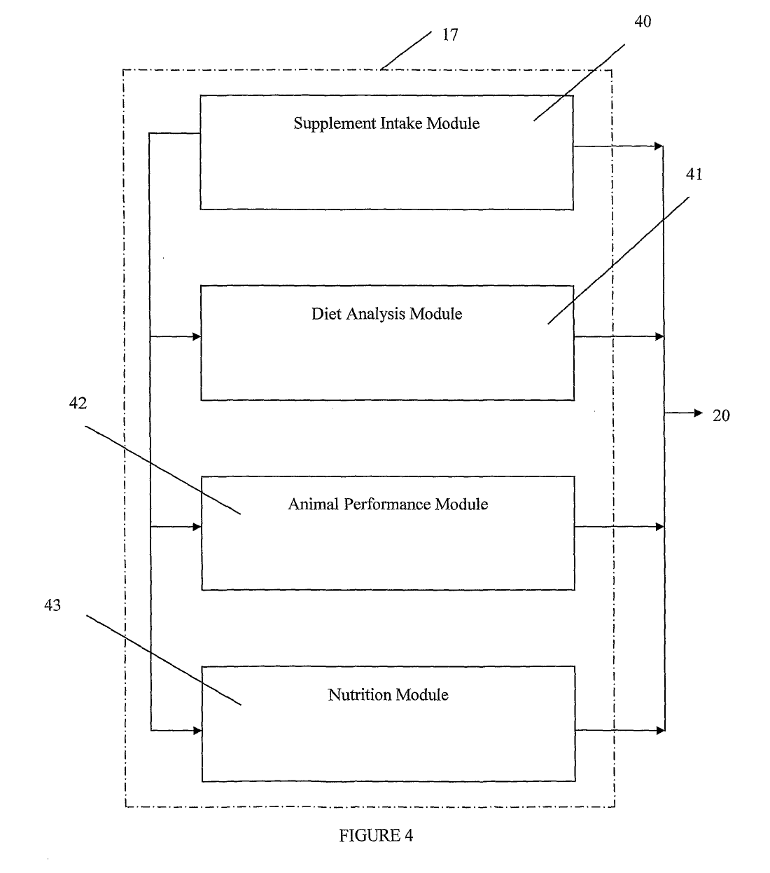

Referring to FIG. 4, the modules of the processor 17 according to a preferred embodiment of the present invention is shown. Module 40 refers to a supplement intake module wherein the supplement intake data obtained from Step 12 above is processed to provide a user with a report showing the individual supplement intake patterns for each animal. Diet Analysis Module 41 performs an analysis of alkane and long chain alcohol contents of the feed components, labelled supplements and faeces to predict total feed intake by each animal and provide a report for each individual animal or herd. Animal Performance Module 42 takes the feed intake information determined by Module 40 as well as other animal performance data such as weight and body scanning obtained from Step 14 referred to above, to provide a report regarding animal selection or breeding information. Nutrition Module 43 takes data generated by modules 40-42 to calculate aspects relating to, for example, feed wastage, optimal least cost supplementation of pasture supplements and digestibility of grain, as well as methane production estimation. Each of the modules 40-43 will be discussed in more detail below.

Supplement Intake Module 40

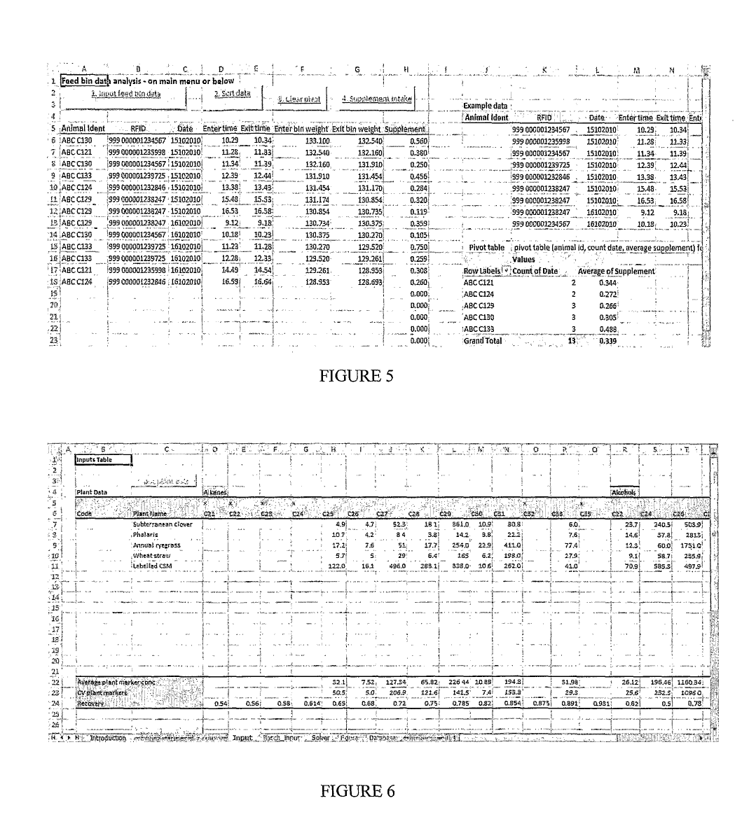

As mentioned relation to step 12 of the present invention, the weekly data from the feed bins (TABLE 1) is output onto a storage device, such as a memory stick in a data file that can be input into a spreadsheet associated with the system software either manually or by downloading the data directly into the spreadsheet. This data is processed into columns in the spreadsheet software as is shown in FIG. 5.

A user can then sort the data in rows A-H by date followed by the individual animal identification, determined by the RFID. A pivot table can then be created by the software that identifies each animal with a count of the number of feeding events and the average of labelled supplement intake for each animal. The pivot table generated by the software of the present invention is shown in the bottom right hand corner of FIG. 5.

As the data collected by the feed bins identified the weight of food consumed by each animal together with time of feeding event, the supplement intake can be readily established for each animal.

Diet Analysis Module 41

The Diet Analysis module 41 of the software of the present invention performs analyses of alkane and long chain alcohol contents of feed components, labelled supplements and faeces, allowing for recovery levels. As previously discussed, it is envisaged that other types of markers may also be included. The module thus enables prediction of total feed intake by each animal by a least squares approach.

The first step of this module is to enter the marker data for the plant components followed by the faecal samples in the Input sheet, as shown in FIG. 6. The data can be entered manually or via files in the required format provided by the marker analytical laboratory.

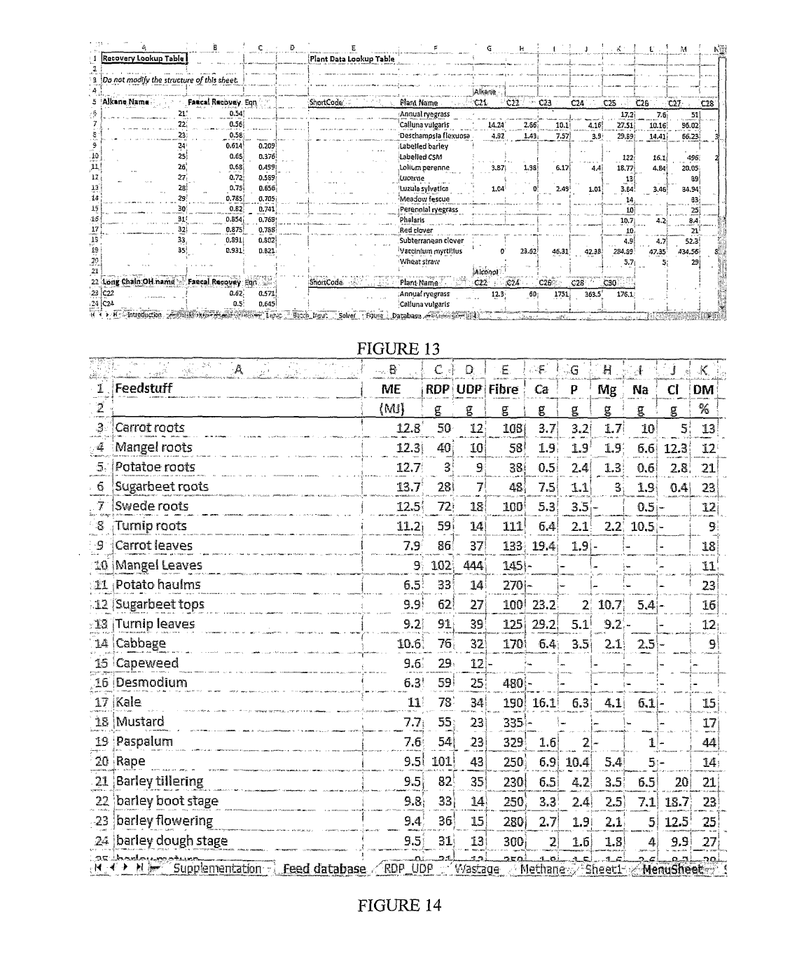

In the example shown in FIG. 6, marker data (mg marker/kg DM) has been added for four plant components and the labelled supplement. Average and CV (Coefficient of Variation) of marker concentrations are calculated automatically by the spreadsheet module as shown in rows 22 and 23 of FIG. 6. The recovery rates of each marker in faeces can be added manually or are automatically set at default values contained in a database sheet, as shown in FIG. 13. Plant component marker data can also be set at the default values in the provided database if no laboratory values are available for pasture components on the property.

An ‘x’ is placed in row 5 of FIG. 6 for any markers that are to be excluded in the analysis. Markers with no data or with values that do not help with diet discrimination, i.e. have very similar concentrations in all feed components, are excluded from further analysis. This can be done manually or can be done automatically based on the calculated marker CV values.

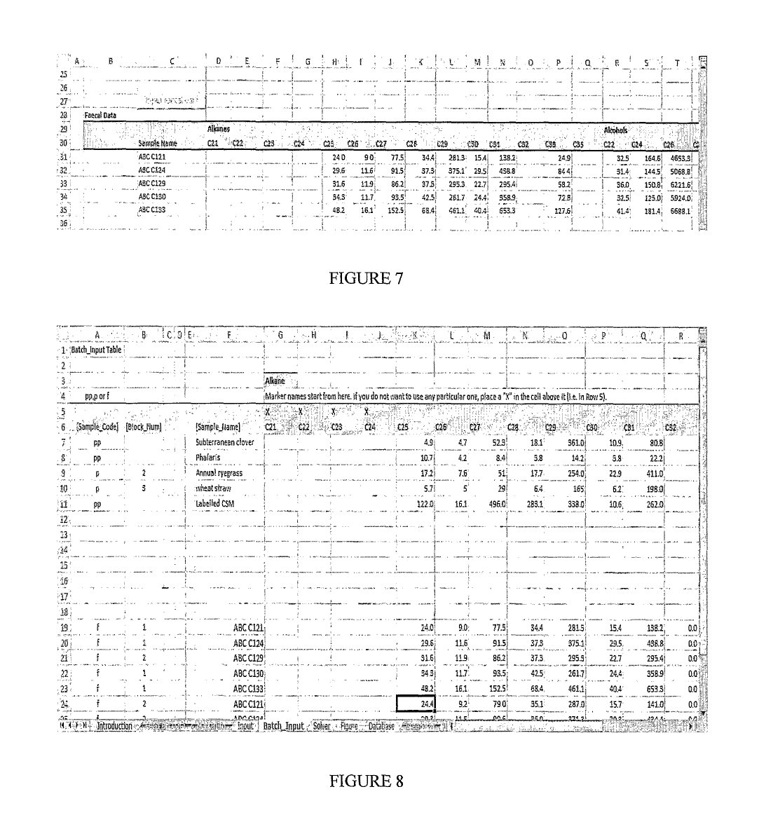

The faecal marker data (mg/kg DM faeces) is added below the plant data, as is shown in rows 31-35 of FIG. 7, either manually or via an input file, for each animal indicated by the ID reference as shown.

If there are different paddocks with different feed components being analysed or different sets of animals in various experiments, the user can choose to use the Batch_Input module as shown in FIG. 8. Typically, the Batch_Input module of FIG. 8 is not a module for routine use by producers/breeders, rather it is designed for use by researchers.

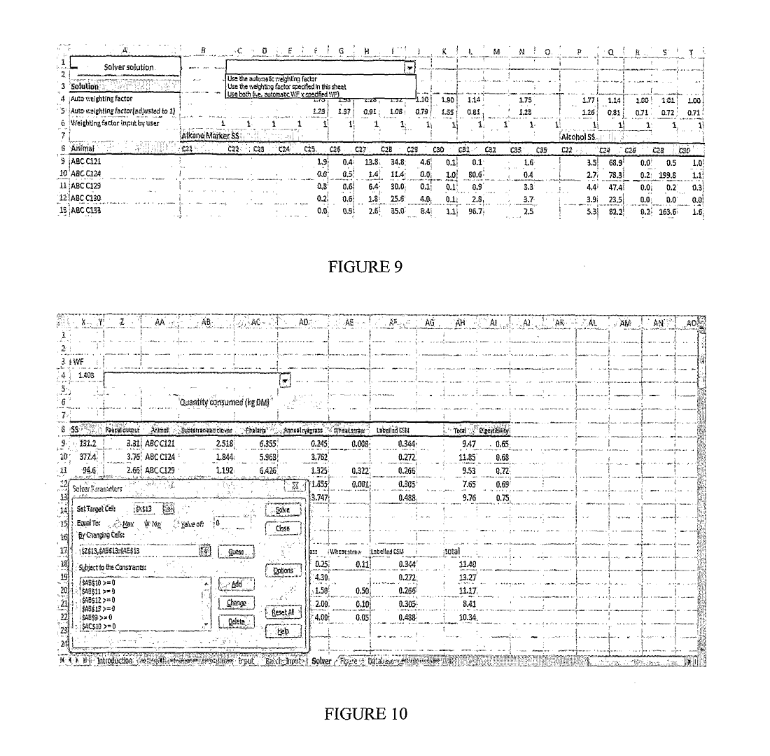

Once the relevant data has been entered into the module, the user can select to perform a calculation by accessing the ‘Solver solution’ module as shown in FIG. 9.

When the ‘Solver solution’ module is selected the module calculates the feed intake of each animal by using a derivation of the least squares approach which is well known in the art and described in Dove and Moore (1995) [Dove H and Moore A D (1995) Aust. J. Agric. Res. 46 1535-1544] and Newman, Thompson, Penning and Mayes (1995) [Newman J A, Thompson W A, Penning P D and Mayes R W (1995) Aust. J. Agric. Res. 46 793-805].

A summary of such an approach is as follows: Consider a problem where the contribution of N species in the diet of an animal is to be estimated from M markers (e.g. alkanes).

Let p be the N-vector of diet proportions
H be an M×N matrix containing the marker concentrations of each species
F be an M-vector containing the marker concentrations in the faeces of each animal
R be an M-vector containing the faecal recoveries of each marker
B be an M-vector containing faecal marker concentrations corrected for recovery, i.e. bᵢ=fᵢ/rᵢ
x be an N-vector denoting the quantity of each species which is consumed to produce 1 kg of faeces.

Following Newman et al. (1995), we can compute p if we know x, as

$$p = \frac{x}{{\sum }_{j = 1}^{N} xi}$$

The problem then becomes one of finding the x which fits the data best (i.e. minimises the squared deviations between observed and fitted faecal marker concentrations) while obeying the constraint that all the xⱼ be greater than or equal to zero:

Min. S²=|Hx−b|²=Σₜ₌₁^{M}(Σⱼ₌₁^{N}hij−bi)²

A derivation of the above approach is used in the Solver solution module. Faecal DM output is allowed to vary rather than being set at 1 kg. The feed intake of the dietary component (supplement) labelled with markers is fixed at the level of its intake measured via the feed bin, rather than being allowed to vary.

In the Solver worksheet as shown in FIG. 10, for the animal identified as ABC C121 in row 9, each cell from B9 to the end of the marker columns is calculated as:

=IF(Input!D$5=“x”,“ ”,(B$6*((Input!D31/Input!D$24)−((Solver!$AB9*Input!D$7)+(Solver!$AC9*Input!D$8)+(Solver!$AD9*Input!D$9)+(Solver!$AE9*Input!D$10)+(Solver!$AF9*Input!D$11))/$Z$9)̂2)).

Each row represents data from each animal.

These cell values are therefore equal to:

Weighting factor*(Faecal marker concⁿ(mg/kgDM)/marker recovery(fraction)−(plant intake(kgDM)*plant marker concⁿ)/faecal output(kgDM)̂2)

Markers can be weighted by their relative value in discriminating between plant components. The statistical methods for optimizing the weight are built into the program. The program provides a weight based on marker, concentrations but this can be overridden manually or not used.

These cells are summed to calculate the sum of squares of the differences between observed and fitted faecal marker concentrations (SS). The least squares, solver solution for each animal is found by minimizing the value of SS, while letting the (constrained to non-negative) intakes of all plant components (except the labelled supplement) vary and the faecal DM output also vary (By changing cells). The intake of the labelled supplement is set at the value calculated for each animal in the pivot table in the feed bin take sheet. Thus the labelled supplement intake cell (Solver!AF9 for the first animal) is not including in the list of cells that can be varied in the solver equation.

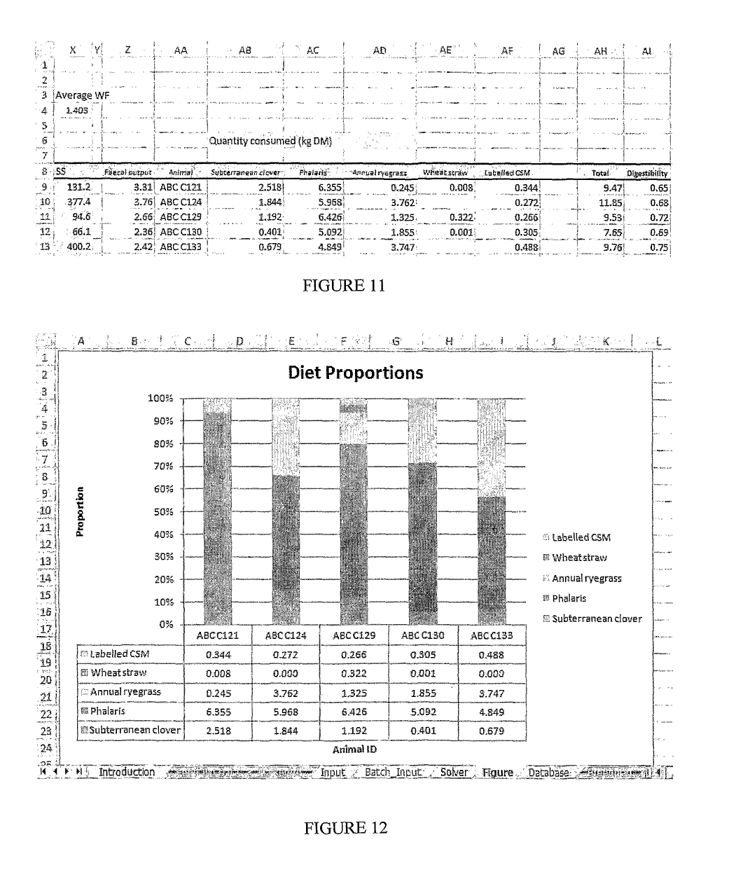

The solver problem for row 13 is shown in FIGS. 10 and 11. In this figure the sum of all the plant component intakes is calculated (column AH) and the digestibility of the whole diet (column AI) is calculated from the estimated faecal output by the formula (Intake−faecal output)/intake, e.g. (AH9−Z9)/AH9 for row 9.

The calculated feed intake values are then shown graphically in terms of proportion of the diet in the Figure worksheet, as is shown in FIG. 12. This provides an overall analysis of the overall configuration of each animal's diet.

To assist in the completion of this module, a database of default marker recovery rates and plant marker concentrations will be available to the user as is shown in FIG. 13.

With the software of the present invention capable of processing raw data into useful animal specific data relating to the intake of supplement for each animal and the proportion of food matter that constitutes each animal's diet, such processed data can be used to control the management of the animals.

In particular, daily feed intake can be estimated based on knowledge of the amount of supplement consumed, then estimating the proportions of supplement and the different forages in the total diet and finally calculating the individual intakes of forages using Equation 1 below, in which:

Iₛ is the intake of supplement;

Pₛ is the proportion of supplement in the diet; and

P_{f} is the proportion of a given forage.

Intake of forage f=Iₛ×(P_{f}/Pₛ)

This approach does not require separate dosing with alkanes, but because it is based on the estimation of diet composition, it requires the correction of faecal alkane concentrations for incomplete faecal alkane recovery. Since cereal and oilseed supplements usually contain only small quantities of cuticular wax alkanes, it is necessary to label supplement with alkanes such as beeswax and C28 alkane. The labelled supplement then has a unique alkane composition. The alkanes used in the analysis are C25 to C31 and C33, and recovery corrections are made using published mean recovery data from experimental animals on similar diets.

It is also possible to determine feed use efficiency of each animal, as a liveweight estimate is obtained at a time near the mid-point between the two faecal samples. The bulking of the 2 faecal samples results in the intake being estimated as the average over that period, so a liveweight measurement in the middle of the period is preferred.

Feed efficiency can be calculated as:

Predicted pasture feed intake(kg)/liveweight gain(kg)over the same period, of 3-6 weeks.

Thus liveweight needs to be measured at the time of measuring supplement and pasture intake and 3-6 weeks later to be able to calculate liveweight gains and relate them to pasture intake. The standard periods for measuring liveweight (growth EBVs) of cattle in BREEDPLAN are at 200 (80-300) days (weaning), 400 (301-500) days (yearling) and 600 (501-900) days (mature). The standard times for measuring liveweight (growth EBVs) of sheep in Sheep Genetics Australia are at 0-1 days (birth) 42-120 days (weaning), 120-210 days (early postweaning), 210-300 days (postweaning), 300-400 days (yearling), 400-540 days (hogget) and >540 days (adult). Thus the timing of liveweight measurements best occurs during one of these periods in Australia, if the raw data are also to be subsequently sent to these Australian Bureau services for analyses. Recommended periods are also available for other countries.

Animal Performance Module 42

The predictions from the Diet Analysis Module 41, as shown in FIGS. 10-12 are automatically transferred to a sheet that can be output to a file used by a variety of commercially available genetic evaluation systems, such as Breedplan™, for estimating breeding values for animals. Breedplan™ is a genetic evaluation system that has been developed by joint venture between the University of New England and the New South Wales Department of Primary Industries and is marketed by the Agricultural Business Research Institute (ABRI). Breedplan™ is a genetic evaluation software that is commercially available and produces Estimated Breeding Values (EBVs) of recorded livestock for a range of important production traits (eg. weight, carcase, fertility). Breedplan™ can receive data from the present module in a standard format for Breedplan™ analyses. Both pasture intake (not including supplement intake) and supplement intake are output for this purpose. The exporting of the information to Breedplan™ for further analysis can be easily performed by the software of the present invention. In is envisaged that options for other breeding service bureaus will also be available with the software of the present invention.

The present software module 42 may also includes linear selection index software that enables the calculation of the weighting factors to be applied to each chosen selection criteria trait for a chosen group of selection criteria and breeding objective traits. The genetic matrix algorithms contained in the software are well established and depend on estimates of trait heritabilities, variances, correlations and economic vales. The module contains default values for all these parameters. The user can choose which traits to use. For example, they may choose to include liveweight gain, feed intake and methane production as both selection criteria and breeding objectives or may choose not to include, say, methane production, as either a selection criterion or breeding objective.

The breeding module equations multiply each selection criterion trait by its calculated weighting factor, sums the trait values and thus calculates an overall index $ value of relative merit for each animal. EBVs for feed intake and liveweight gain are calculated by multiplying the calculated (phenotypic) values of pasture feed intake and liveweight by weighting factors that take into account the genetic parameters for all traits of interest using selection index theory that is built into a sheet in the spreadsheet program. This allows animals to be ranked, selected or culled on an overall combination of weight gain, feed intake and predicted methane production, as well as calculating the estimated breeding value (EBV) of individual traits. The EBV of feed efficiency (feed intake/liveweight gain) for each animal can also be calculated if it is required. The EBVs and index ranks are only approximate as they do not correct for non-genetic effects, such as the animal's birth status (single/twin/triple), age of its dam (maiden,/adult), sex (if mixed sex) or date of birth (exact age). They also do not correct for genetic effects, such as pedigree information (e.g. sire or dam or siblings) and cannot be used to compare animals in different herds or flocks.

Nutrition Module 43

The estimated feed intakes from the Diet Analysis Module 41, can also be used for a variety of non-genetic purposes. These may include:

Least Cost Supplementation

Each animal's weight and their user-defined desired weight gain are used to estimate each animal's feed requirements (in terms of metabolisable energy (ME), rumen degradable protein (RDP), rumen undegradable or bypass protein (UDP), Ca and P) from equations stored in the program. The nutrients provided by the animal's pasture intake, automatically calculated from the composition of the diet and feed composition tables stored in the program, are subtracted from each animal's feed requirements to estimate its residual, if any, requirements from supplementation.

The user selects possible supplement components and updates a feed composition table (FIG. 14) with the price of supplement components or supplements and any feed mill or laboratory analyses made on potential components or proprietary supplements. Otherwise stored default values are used.

The module of the present invention is then used to calculate the least cost supplement mix and amount that best meets each animal's residual nutrient requirements. This can also be done on an ‘average of all animals’ basis, so that the best supplement to feed the herd as a whole can be calculated. The amount of this supplement fed to each animal, if this can be controlled, can also be calculated. Alternately the amount of a proprietary supplement that should be fed to the herd can be calculated.

Wastage Calculations

The module of the present invention also makes it possible to calculate the amount of feed wastage. This is achieved by obtaining the total intake of all animals in the herd for each feed component and subtracting this from the known amounts of any feed component fed to calculate the amount of feed wastage. The user can then act to reduce feed wastage and reduce monetary costs associated therewith.

Further to this, if the concentration of starch is measured in the faeces of animals and appropriate laboratory tests are obtained, the program of the present invention can calculate the digestibility of grains in the diet of each animal. This can then enable alteration of the diet to maximise digestibility for the herd.

Methane Predictions

The present module also enables the amount of methane produced from each animal to be estimated from DMI using the following equation.

Methane(MJ/d)=10.8*(1−e^{-0.141*DMI(kg/d)}).

The methane is presented as a ratio to DMI, LW and MEI for each animal.

If lipids in rumen methanogens are measured in the faeces of animals this may also be used to estimate methane production.

It will be appreciated that with the system and method of the present invention, by using published phenotypic and genetic correlations between methane production, feed intake and liveweight gain, combined with various genetic parameters, i.e. the heritabilities, relative economic values and variance of traits, the estimated breeding value (EBV) of each animal for feed intake, feed efficiency, liveweight gain and methane production and overall economic merit can be calculated using selection index theory. The unprocessed animal data can also be output from the software to be sent in suitable formats to (bureau) breeding services, e.g. Breedplan™ and Sheep Genetics, or other proprietary breeding software, for calculation of industry standard EBVs.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the invention described herein without departing from the spirit and scope of the invention.

1. A system for monitoring the feeding characteristics of grazing animals in a pasture comprising:
one or more feeding bins for dispensing supplement to said grazing animals, at least one of the feeding bins being configured to identify each animal receiving supplement therefrom and being configured to measure and record an amount of supplement being dispensed to each animal;
a marker labelled supplement for dispensing from the one or more feed bins to at least one animal;
a weighing device for determining weight gain of each individual animal;
a faeces collection means for obtaining faecal samples from at least one of said grazing animals;
an analysis means for analysing said faecal samples and samples of pasture and supplement to provide data representative of marker concentrations in an animal's faecal sample, pasture and the supplement; and
a processor for receiving said amount of supplement being dispensed to an animal, the weight gain of the animal and data representative of marker concentrations in an animal's faecal sample, pasture and the supplement and processing said data to determine an animal's pasture feed intake, the animal's feed use efficiency and/or methane production for animal breeding, management and/or experimental purposes.

2. A system according to claim 1, wherein each feed bin comprises one or more load cells to determine amount of supplement consumed by each animal and an RFID reader to identify each individual animal.

3. A system according to claim 1, wherein the feed bins are portable enabling movement of the feed bin between pastures.

4. A system according to claim 2, wherein the processor determines consumption intake of supplement by each animal by measuring a loss in feed bin weight during feeding events matched to RFID tags worn by each individual animal.

5. A system according to claim 4, wherein the processor calculates individual pasture intake from supplement intake and marker concentrations in feed, pasture and faeces samples.

6. A system according to claim 1, wherein the processor determines feed use efficiency and liveweight gain of individual animals.

7. A system according to claim 1, wherein the computer program determines the ranking of animals, for breeding based on EBVs for feed use efficiency and/or methane production.

8. A system according to claim 1, wherein the computer program calculates the biological efficiency of the livestock system.

9. A system for monitoring the feeding characteristics of grazing animals in a pasture comprising:
one or more feeding bins for dispensing supplement to said grazing animals, at least one of the feeding bins being configured to identify each animal receiving supplement therefrom and being configured to measure and record an amount of supplement being dispensed to each animal;
a marker labelled supplement for dispensing from the one or more feed bins to at least one animal;
a weighing device for determining weight gain of each individual animal;
a faecal collection means for obtaining faecal samples from at least one of said grazing animals;
an analysis means for analysing said faecal samples and samples of pasture and supplement to provide data representative of marker concentrations in an animal's faecal sample, pasture and the supplement; and
a processor for receiving said amount of supplement being dispensed to an animal, the weight gain of the animal and data representative of marker concentrations in an animal's faecal sample, pasture and the supplement and processing said data to determine an animal's pasture feed intake, the animal's feed use efficiency and/or methane production for animal breeding, management and/or experimental purposes.

10. A method for monitoring the feeding characteristics of a grazing animal in a pasture comprising the steps of:
dispensing supplement to said grazing animal, said supplement containing a marker labelled supplement;
identifying said animal receiving said supplement and storing information associated with an amount of supplement being dispensed to said animal; weighing said animal and storing information pertaining to weight gained by each animal;
collecting faecal samples from said animal;
analysing said pasture and supplement and said faecal samples to provide data representative of marker concentrations in said animal's faecal sample, pasture and the supplement;
processing said information associated with an amount of supplement dispensed to said animal, the information pertaining to weight gained by said animal and data representative marker concentrations in said animal's faecal sample, pasture and the supplement; and
generating data to determine said animal's pasture feed intake, feed use efficiency and/or methane production for animal breeding, management or experimental purposes.

11. A method for the management of animals grazing in a pasture, comprising:
feeding a marker labelled supplement to grazing animals-monitoring consumption of said marker labelled supplement by said animals to generate supplement consumption data for said animals;
measuring physical characteristics of said animals to generate physical characteristic data for said animals;
collecting faecal samples from said animals;
analysing said faecal samples, samples of said pasture and said supplement to generate faecal data, pasture data and supplement data; and
processing said supplement consumption data, said physical characteristic data and said faecal data, pasture data and supplement data to determine individual animal diet and nutritional information for animal management purposes.

12. A method according to claim 11, wherein the step of monitoring consumption of said marker labelled supplement includes identifying each individual animal consuming said supplement, measuring the amount of supplement consumed by each individual animal and storing said information.

13. A method according to claim 12, wherein each individual animal carries a unique identification tag and the amount of supplement consumed by each animal is measured by weight.

14. A method according to claim 11, wherein the supplement may be in liquid or solid form.

15. A method according to claim 14, wherein the individual diet and nutritional information includes individual animal supplement intake amount.

16. A method according to claim 11 wherein the individual diet and nutritional information includes determining a breakdown of the intake of plant components present in the pasture.

17. A method according to claim 11, wherein the individual diet and nutritional information includes feed use efficiency and/or feed wastage.

18. A method according to claim 11, wherein the individual diet and nutritional information includes methane production.

19. A method according to claim 12, wherein the supplement may be in liquid or solid form.

20. A method according to claim 13, wherein the supplement may be in liquid or solid form.
